(19) United States
(12) Patent Application Publication
(10) Pub. No.: US 2007/0017640 A1
(43) Pub. Date: Jan. 25, 2007

(54) Applicator for labelling apparatus

(76) Inventor: Alan Constantine, Norwich (GB)

Correspondence Address: BARLOW, JOSEPHS & HOLMES, LTD., 101 DYER STREET, 5TH FLOOR, PROVIDENCE, RI, 02903, US

(21) Appl. No.: 10/489,890

(22) PCT Filed: Sep. 18, 2002
(86) PCT No.: PCT/GB02/04246

§ 371 Date: Sep. 14, 2004

(30) Foreign Application Priority Data
Sep. 18, 2001 (GB) 0122414.6

(51) Int. Cl. B65C 9/26; B65C 9/36

(52) U.S. Cl. 156/538; 156/DIG. 37; 156/DIG. 42

(57) ABSTRACT

An improved applicator for a labelling apparatus comprises a removable tip (13) for ease of replacement or repair.

This invention relates to an improved applicator for labelling apparatus, particularly although not exclusively for labelling apparatus for applying labels to fruit and/or vegetables.

Fruit and vegetable labelling apparatus of the type disclosed in European Patent No. 0113256 utilise an expandable flexible bellows applicator to apply labels to the exterior of individual fruit and vegetables without damaging the fruit or vegetable during labelling.

Conventionally, these bellows applicators are formed in one piece by moulding from a flexible material.

Problems have arisen through the use of one piece bellows applicators since that part of the bellows which collects the label and impacts on the fruit or vegetable, the tip part, can wear rapidly. This can result in a reduction in the ability of the bellows applicator to pick up labels for application, which can cause a substantial decrease in labelling efficiency. It then becomes necessary to replace the entire bellows applicator, which can be expensive.

Furthermore, because a moulding process is used to manufacture the bellows applicator, and because of the deep folds that make up the walls of the bellows, it is essential that the material from which the bellows is moulded has a high hot tear strength and good elongation to resist tearing when the bellows is removed from a hot mould. These qualities generally do not combine with good durability and wear resistance, which are ideal properties for the bellows tip.

The present applicants have realised that it would be advantageous to provide a separate replaceable applicator tip part formed from a more durable material to reduce wear and also to enable replacement of the tip part only when required thereby reducing costs.

Thus and in accordance with the present invention therefore there is provided an improved applicator for a labelling apparatus, said applicator comprising a flexible applicator member adapted to receive a label on a tip part thereof for application to a fruit or vegetable, said tip part being formed separately from said applicator member and being adapted for releasable cooperating engagement therewith.

With this arrangement it is possible to provide cheap and simple means by which a worn tip part of an applicator member can be replaced. Further because the tip part is formed separately, it can be formed from a more durable material without effecting the moulding of the applicator member.

Preferably the tip part is adapted for releasable cooperating engagement with an exterior surface of said applicator member. Alternatively, the tip part may be adapted for releasable cooperating engagement with an interior surface of said applicator member.

In a particularly preferred embodiment, cooperating formations are provided respectively on said applicator member and said tip part to releasably secure the applicator member and the tip part together. The cooperating engagements may comprise interlocking formations in the form of projecting locking formations respectively provided on said member and said tip part.

In an alternative embodiment, the cooperating engagement takes place between a suitably shaped projecting flange on said tip part which engages either the internal or external surface or the applicator member.

The invention will now be described further by way of example only and with reference to the accompanying drawings, in which:—

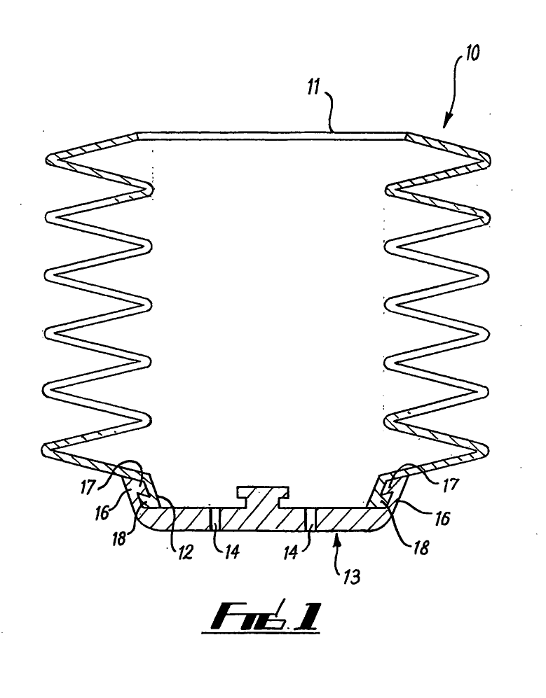

FIG. 1 shows a diagrammatic side view of one form of applicator in accordance with the present invention;

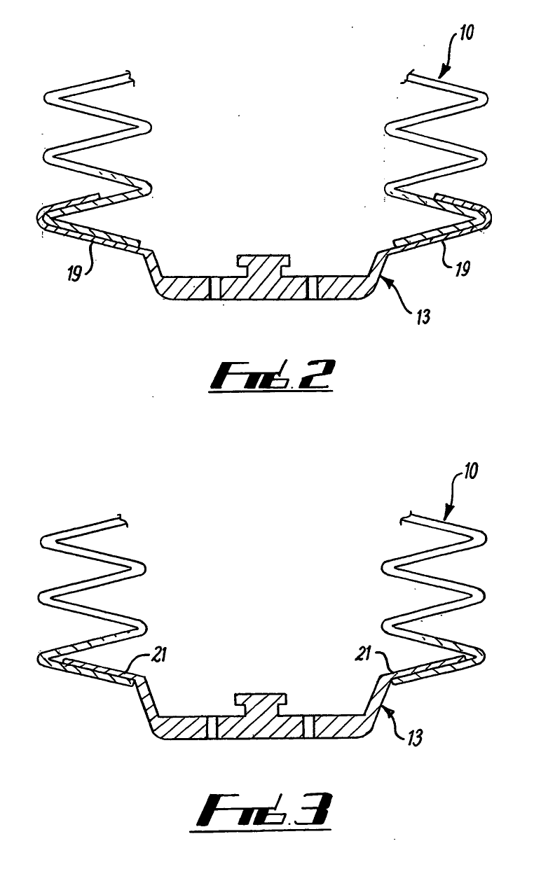

FIG. 2 shows an alternative embodiment of applicator in accordance with the present invention; and

FIG. 3 shows a further alternative embodiment of applicator in accordance with the present invention.

Referring now to the drawings, there is shown in FIG. 1 a label applicator 10 of bellows form of the kind disclosed in European Patent No. 0113256 for use in a labelling apparatus for labelling fruit and vegetables individually. The manner in which the applicator 10 functions in a labelling apparatus is disclosed in European Patent No. 0113256 and no further description will be given herein.

The applicator 10 is formed from a flexible material by way of a moulding process into a convoluted bellows form as shown in the figures. However contrary to prior art arrangements, the applicator 10 is formed so as to be open at both ends 11, 12 thereof in so far as the tip part of the applicator which would normally be formed in one piece with the applicator 10 and which would receive and hold labels and contact the fruit or vegetables during labelling is absent. A separate tip part 13 is formed of durable plastics material and includes bores 14 therethrough to allow airflow through the tip part 13 into and out of the applicator as in the prior art arrangements to allow labelling to take place.

The tip part 13 has upwardly directed side members 16 which have locking projections 17 projecting therefrom. The applicator 10 also has corresponding locking projections 18 on one end thereof which can cooperate with the locking projections 17 on the tip part 13 to hold the tip part 13 in place over the end 12 of the applicator 10.

With the tip part 13 attached to the applicator 10, the applicator will function exactly as described in for a prior art one piece applicator.

An alternative embodiment is shown in FIG. 2, which differs from the embodiment of FIG. 1 only in that the releasable cooperating engagement of the tip part 13 with the applicator 10 is different. In this embodiment, the tip part 13 includes an upwardly extending shaped flange 19 which engages the convoluted exterior surface of the applicator member so as to hold the tip part 13 in position.

A further alternative embodiment is shown in FIG. 3 which differs from the embodiments of FIGS. 1 and 2 in that the releasable cooperating engagement of the tip part 13 takes place by way of a projecting flange 21 on the tip part 13 which is shaped to engage an interior surface of the convoluted applicator 10.

In all of the above embodiments, the tip parts 13 are easily and simply removable for replacement if excessively worn without the need to replace the entire applicator. Furthermore, by forming the tip part 13 as a separate piece this means that it can be formed from a more durable material without effecting the hot tear characteristics of the material from which the applicator member is formed and therefor the tip part can be made less prone to wear. Still further, by forming the tip part 13 as a removable separate element, different tip parts with different characteristics or formed from different materials can be utilised for different applications. Thus tip parts can be interchangeable dependent on the labelling being carried out to maximise operational efficiency and effectiveness of the labelling apparatus. Furthermore, replacement of a tip part 13 rather than the entire applicator results in a tremendous cost saving to users of labelling apparatus by reducing the cost of maintenance of the apparatus in working order.

It will of course be appreciated that the invention is not intended to be restricted to the details of the above embodiments which are described by way of example only.

1. An improved applicator for a labelling apparatus, said applicator comprising a flexible applicator member adapted to receive a label on a tip part thereof for application to a fruit or vegetable, said tip part being formed separately from the applicator member and being adapted for releasable co-operating engagement therewith.

2. An improved applicator according to claim 1 wherein the tip part is adapted for releasable co-operating engagement with an exterior surface of said applicator member.

3. An improved applicator according to claim 1 wherein the tip part is adapted for releasable co-operating engagement with an interior surface of said applicator member.

4. An improved applicator according to claim 1, wherein co-operating formations are provided respectively on said applicator member and said tip part to releasably secure said applicator member and the tip part together.

5. An improved applicator according to claim 4 wherein the co-operating engagement comprises interlocking formations in the form of projecting locking formations respectively provided on said member and said tip part.

6. An improved applicator according to claim 4 wherein the co-operating engagement takes place between a suitably shaped projecting flange on said tip part which engages said internal or external surface of the applicator member.
